(19) United States
(12) Patent Application Publication
(10) Pub. No.: US 2009/0241361 A1
(43) Pub. Date: Oct. 1, 2009

(54) Handheld diameter gage

(76) Inventor: Donnald Craig Strutton, Glendale, AZ (US)

Correspondence Address: Donnald Craig Strutton, 4034 W. Cielo Grande, Glendale, AZ, 85310, US

(21) Appl. No.: 12/079,320

(22) Filed: Mar. 27, 2008

(51) Int. Cl. G01B 5/08; G01B 3/12

(52) U.S. Cl. 33/780; 702/157

(57) ABSTRACT

A handheld device used to measure and display the average inner or outer diameter of cylindrical or nearly cylindrical parts. A wheel of a known radius rolls along the surface of a part along a path that is parallel to the edge of the part. The rotation angle of the wheel is counted to determine the length traveled by the wheel. A clip is placed onto the edge of the part in order to trigger the beginning and ending of wheel rotation counting. The average diameter of the part is equal to the wheel radius multiplied by the wheel rotation angle in radians. The average diameter of the part is displayed on either a mechanical display or an electronic display.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Measuring the average inner diameter or out diameter of parts during manufacturing is a needlessly time consuming process. There is no quick way of measuring the average inner diameter of slightly out-of-round parts with a diameter between 3″ and 6″. It is sometimes useful to measure the diameter of a part at a given distance away from the edge of the part. Using current methods, without special made tooling this can take an incredibly long time.

### BRIEF SUMMARY OF THE INVENTION

A hand held device used, in conjunction with a clip to hold the measurement start and stop position, to measure the average diameter of a part, or the length along a surface. The device can measure the average diameter of a part at preset depth in from the edge of the part. The device can either be electronic or mechanical.

### BRIEF DESCRIPTION OF THE SEVERAL VIEWS OF THE DRAWING

FIG. 1 shows a cut away side view of the invention.

FIG. 2 shows an axial view of the trigger mechanism.

FIG. 3 shows a 3^{rd} angle projection of the start/stop clip.

FIG. 4 shows axial views of the depth position keeper clamp in the closed and open positions.

FIG. 5 shows an axial view of the gear train.

FIG. 6 shows an example mechanical display.

### DETAILED DESCRIPTION OF THE INVENTION

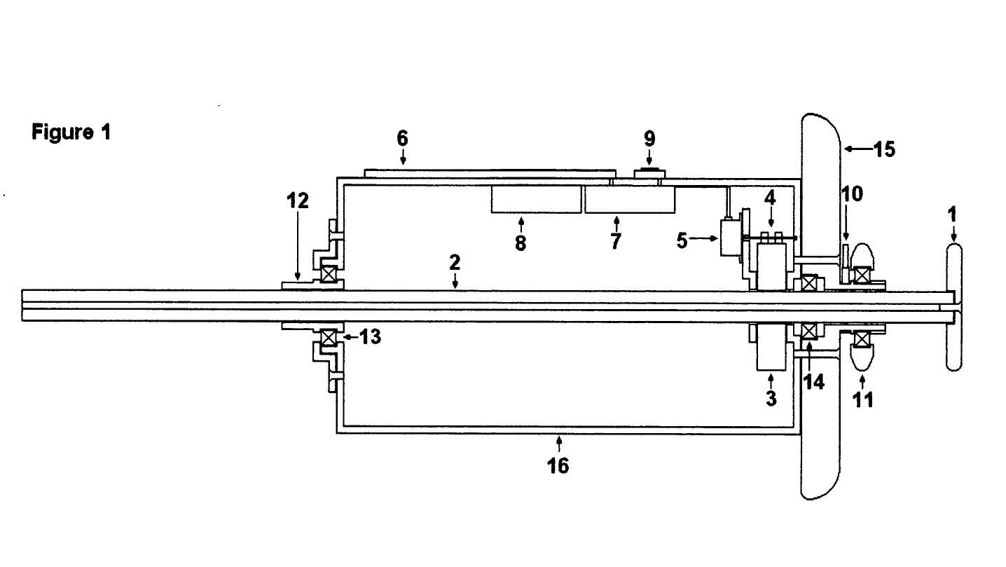

Referring to FIG. 1, the measurement wheel 1 has a known radius. It is fixed to the end of a keyed shaft 2. The keyed shaft 2 is held in the housing 16 by bearings 13 and 14, and kept from sliding axially by the depth position clamp 12. During operation the measurement wheel 1 is kept in contact with the part surface and rolled along its surface. The keyed shaft 2 rotates as the measurement wheel 1 rolls along the part surface. A gear 3 mounted on the keyed shaft then rotates. This gear turns a set of anti-backlash gears 4 which are mounted onto the axle of the rotation counter 5.

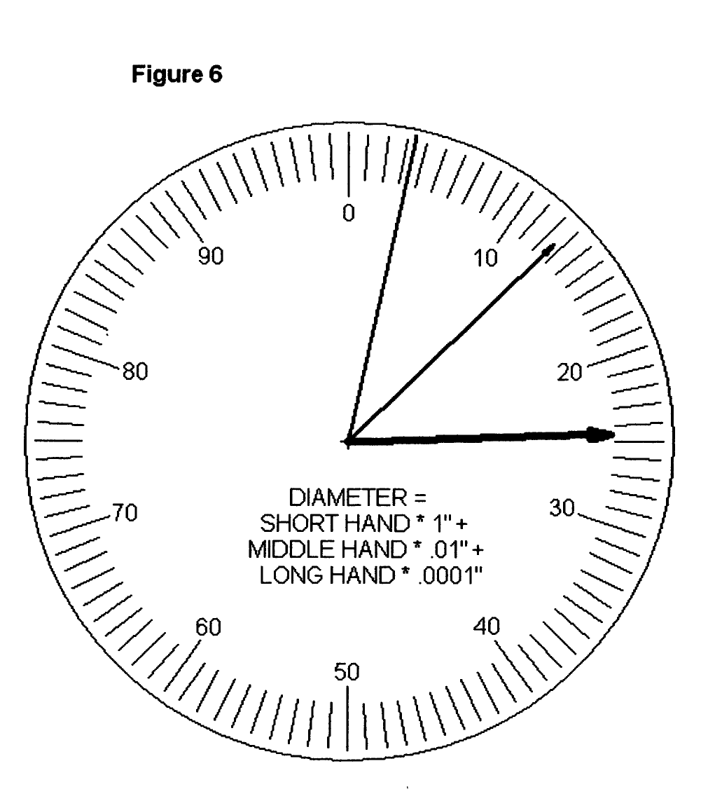

If the device is mechanical then the rotation counter 5 turns the hands on the display 6 dial. Refer to FIG. 6 for an example dial. If the device is electronic then the rotation counter 5 creates electric signals as its shaft rotates. These electric signals are counted in the controller/recorder 7. The count of electric signals from the rotation counter 5 are converted to a diameter measurement in the controller/recorder 7 and displayed on an electronic display 6. The reset button 9 is pressed to clear the display and reset the angle counter so it can be triggered by the trigger 10.

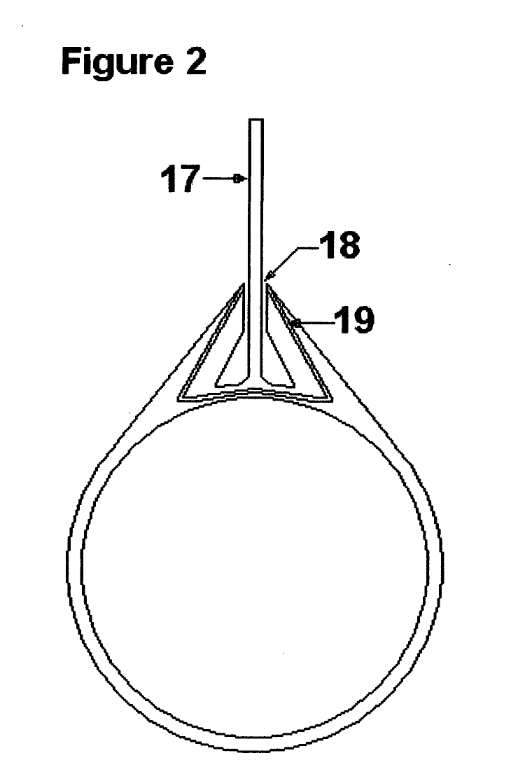

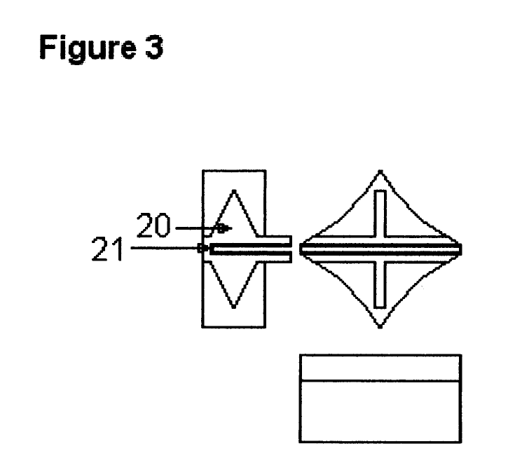

A trigger 10 is mounted on an extension of the housing 16, surrounding the keyed shaft 2. When the trigger 10 is twisted around the axis of the device it either starts or stops the angle counting. During operation the trigger 10 is twisted around the device axis when it runs over the start/stop clip seen in FIG. 3. The first time the trigger 10 is twisted, after the device is reset, the rotation counter 5 begins counting the measurement wheel 1 rotation angle. The second time the trigger 10 is twisted the rotation counter 5 stops counting the measurement wheel 1 rotations. If the device is mechanical the trigger 10 engages a clutch in the rotation counter 5 to rotate the display 6 dials thereby recording the diameter. If the device is electronic the trigger 10 switches the controller/recorder 7 on or off, to begin or stop counting the electronic signals from the rotation counter 5. FIG. 2 shows an axial view of an electronic trigger 10. The trigger 10 consists of a thin lever 17 which completes a circuit when it pushes an electric contact 18 into another electric contact 19 located in one of two protrusions extending from the trigger base. A guide wheel 11 is mounted concentric to the keyed shaft 2 just beyond the trigger 10. The guide wheel 11 protects the trigger 10 from accidental twisting during measurement.

If the device is twisted axially in relation to the part during measurement the reading will still be accurate because the trigger will be twisted by the same amount. In one possible scenario, the measurement wheel 1 is ahead of the trigger 10 at the start of the measurement and is behind the trigger 10 at the end of the measurement. This would require the device to be twisted axially in relation to the part. This rotation is counted by the rotation counter as if the measurement wheel 1 rotated more times than it really did. This scenario results in the measurement wheel 1 traveling less than the circumference of the part. If the length of the trigger 10 lever (distance from keyed shaft axis to end of trigger) is the same as the radius of the measurement wheel 1 then the rotation of the device relative to the part offsets the fact that the measurement wheel 1 traveled less than the circumference of the part. A similar but opposite effect takes place if the measurement wheel 1 is behind the trigger 10 at the start of measurement and ahead of the trigger 10 at the end of measurement. The trigger 10 lever must be shorter than the radius of the measurement wheel 1 otherwise it would drag along the part surface during measurement and not trigger at the proper position. The trigger 10 lever can be shortened as long as the length of the trigger 10 together with the length of the start/stop clip from FIG. 3 is the same as the radius of the measurement wheel 1. The curved surface of the start/stop clip must be tangent to and coincident with the part surface at its ends and must have a radius of curvature equal to the length of the trigger 10 lever. Referring to FIG. 3 the inside surface 21 of the start/stop clip is treated to prevent it from slipping on the part. The start/stop clip provides a force normal to the part surface on both sides. This could be accomplished by a spring like device. The inside of the start/stop clip shown in FIG. 3 is one such spring like device 20.

The axial position of the housing 16 is held by the shoulder 15 which rest on the end of the part. The shoulder 15 also serves to protect the hand of the operator from the edge of the part. The axial position of the housing 16 holds the axial position of the depth position keeper 12 which hold the axial position of the keyed shaft 2 which holds the position of the measurement wheel 1. This all ensures the path taken by the measurement wheel 1 during measurement is parallel to the edge of the part. The edge profile of the measurement wheel 1 is rounded so there is only one edge for the measurement wheel 1 to roll on. If there were multiple edges then the measurement wheel 1 could catch on one edge then another during the same measurement which could give a false reading. The outside surface of the measurement wheel 1 can be treated to prevent it from slipping on the part.

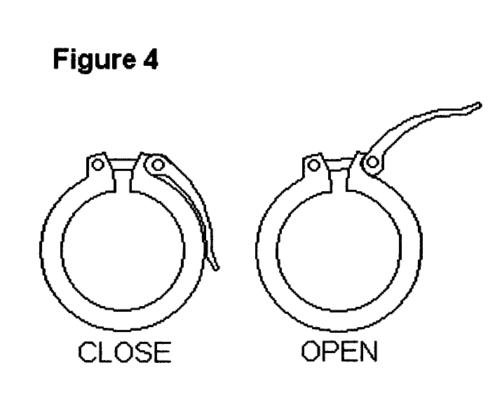

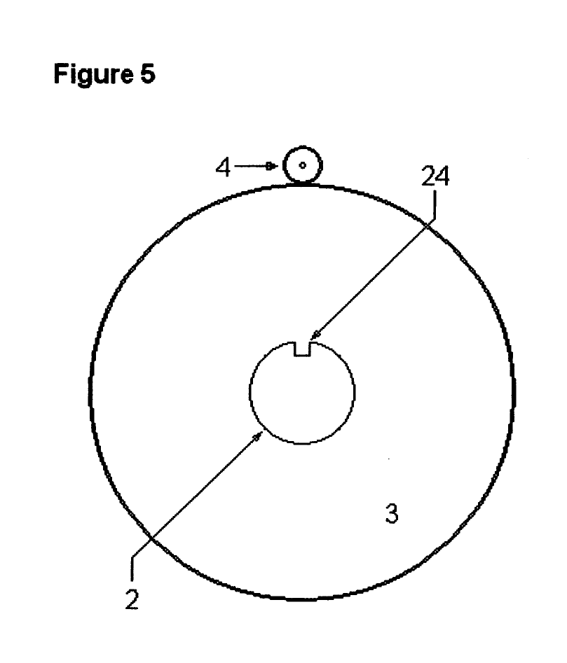

The keyed shaft 2 is marked with graduations which correspond to how far into the part the diameter is to be measured. The depth into the part at which the measurement is to be taken is given by the where the indicator on the depth position keeper 12 lines up with the graduations on the keyed shaft 2. The depth shown on the keyed shaft 2 graduations is the axial length from the surface of the shoulder to the edge of the measurement wheel 1 which comes in contact with the surface of the part. The keyed shaft 2 is held in the desired axial position by the depth position keeper 12 clamp see FIG. 4. Referring to FIG. 5, the center of the gear 3 mounted on the keyed shaft 2 has two opposed spring loaded catches 24 that ensure the rotations of gear 3 match that of the keyed shaft 2.

1. A handheld device for measuring the inner or outer average diameter of a cylindrical or nearly cylindrical part, comprised of:
A wheel of known radius mounted on the end of a shaft. The shaft is held axially by a clamp which is held axially and radially by a bearing which is mounted in the housing. Another bearing can be used to limit the shaft to rotating only around its axis. The end of the housing, from which the wheel of known radius protrudes, contacts the edge of the cylindrical part so that the shaft axis is held parallel to the axis of the cylindrical part. The side of the wheel of known radius contacts either the inner surface or the outer surface of the part. With the aforementioned contacts held the device is brought around the cylindrical part. The position of the measurement wheel relative to the end of the housing, which determines the depth from the edge of the part where the diameter is measured, is given by graduations scribed into the shaft. The wheel of known radius rotates as it rolls across the part surface. The length that the wheel rolls along the part surface for one pass is the part circumference, which is equal to the radius of the wheel multiplied by the wheel angle of rotation for one pass in radians. The average diameter of the part is equal to the part circumference divided by pi. The wheel angle of rotation is counted for exactly one complete pass around the part, by either an electronic rotation counter or mechanical gears that rotate hands on a dial. The angle counting is started and stopped at exactly the same location on the part by a trigger device that is mounted in the housing. The trigger device is activated by a clip that is held in place at the edge of the part by friction. The average diameter of the part is displayed using an electronic display for devices using an electronic rotation counter.
